(19) United States
(12) Patent Application Publication
(10) Pub. No.: US 2003/0182143 A1
(43) Pub. Date: Sep. 25, 2003

(54) Image capture system

(75) Inventors: Linda D. Conrad, Celebration, FL (US); Michael A. Colglazier, Orlando, FL (US); Renee Thibodeaux, Windermere, FL (US)

Correspondence Address: GREENBERG TRAURIG LLP, 2450 COLORADO AVENUE, SUITE 400E, SANTA MONICA, CA, 90404, US

(73) Assignee: Walt Disney Parks and Resorts

(21) Appl. No.: 10/318,431

(22) Filed: Dec. 13, 2002

Related U.S. Application Data
(60) Provisional application No. 60/340,437, filed on Dec. 13, 2001.

(51) Int. Cl. G06F 17/60; G06F 15/16

(52) U.S. Cl. 705/1; 709/218

(57) ABSTRACT

The present invention aims to create a more pleasant and rewarding guest experience by providing a centralized system for capturing many different types of images from multiple sources throughout a theme park. The present invention utilizes an ingenious method of attaching identity to photographs taken. The present invention then stores the photographs centrally and provides unique and convenient methods for guests to view their photos. The present invention further provides many options other than simply ordering traditional prints of their favorite photo.

### RELATED APPLICATIONS

This application claims priority to U.S. Provisional Application Serial No. 60/340,437 entitled “Image Capture System,” filed on Dec. 13, 2001 which is incorporated herein by reference in its entirety.

### BACKGROUND OF THE INVENTION

1. Field of the Invention

The invention relates to image capture and access. More particularly, the invention relates to a system and method of capturing images from multiple sources and properly delivering the images to the correct person in a convenient fashion.

2. General Background and State of the Art

Photo taking has always been an important part of the experience of a vacation or visit to a popular amusement park. It is a popular way to record memories and experiences for those on vacation, allowing people to have something tangible to take away from their trip. Photographs allow people to be reminded of fond memories and cherish them for much longer. In fact, photos are perhaps the most important “takeaway” for people on vacations or visits to special places. For example, approximately five percent of all photographs taken in the United States are taken at Walt Disney World or Disneyland. Last year alone, 8.8 million photos were taken at Disney World/Disneyland of guests capturing over 12.6 million family groups.

Taking these figures into consideration, many theme parks have employed the use of photographers to roam the parks to take photos of families, later offering the photos for sale as a souvenir. This provides families or groups with the opportunity to capture the whole group without any one person being left out. Theme parks also employ other methods of capturing photographs, allowing guests to take home memories they cannot easily capture with their own cameras. For example, cameras may be mounted in a strategic position on a ride and be configured to take photographs every few seconds, capturing images of people unaware that the camera is watching them. These cameras often capture candid expressions that cannot be captured by a person easily, and create a unique and special memory for guests to take away with them.

The previously mentioned methods have some drawbacks associated with them. The method in place ensuring that guests receive the correct photograph at the end of the day was quite unsophisticated. Usually the system involved the roving photographer carrying numbered paper tickets, which were given to the guest every time a photograph was taken. The guest would then use the numbered ticket to claim their photograph at the end of the day, which was labeled with the corresponding number. Unfortunately, it was all too common for guests to lose their small paper tickets and not be able to claim their photograph. Also, since photos were taken with traditional film, it took a while for the photos to be developed. The process involved in picking up photographs was not very sophisticated, and long lines would form towards the end of the day. These long waits discouraged guests from purchasing photographs. There was also no place to purchase these photographs other than a few select locations within the park.

### SUMMARY OF THE INVENTION

The image capture system and method of the present invention aims to create a more pleasant and rewarding guest experience by providing a centralized system for capturing many different types of images from multiple sources throughout a venue such as a theme park. The present invention utilizes an ingenious method of attaching identity to photographs taken. The present invention then stores the photographs centrally and provides unique and convenient methods for guests to view their photos. The present invention further provides many options other than simply ordering traditional prints of their favorite photo.

Within a venue such as a theme park or vacation spot there may be a number of different sources of photo capture. These sources may include traditional film cameras and digital cameras carried by roving photographers, cameras mounted in various locations throughout the park that may be triggered by the guest, or automatically by a sensor. Thrill ride photo capture involves capturing candid images of guests while on a ride, and is also common at many theme parks. Additionally, drop boxes or digital order and reviewing stations may be located throughout the park for guests to drop their own film and media.

The present invention involves assigning identification to a guest attending a venue such as a theme park or vacation spot through ID means or media, and providing convenient methods by which the identification means is used at various sources of photo capture throughout the park to mark the identity of each photo taken. Each source of photo capture is then capable of communicating the photos taken to a central location, where all photos are sorted according the identification means used to mark each photo at the source of photo capture. Photos are then digitally delivered to the proper guest account for viewing.

The identification means may be a number of types of media. For example, the guest may be issued a card with a magnetic stripe to swipe at each photo capture location. Similarly, the identification media could use radio frequency or infrared signals, whereby the guest is issued media which transmits a signal to a device at each source of photo capture. Other types of technology which could be used include bar codes, iris, fingerprint, retina, voice, thermal, finger or hand geometry, and visual identification. Ideally, the method would be very low cost, very simple to use, and consistent throughout properties.

Preferably, each source of photo capture is able to transfer the photos it takes, quickly and easily, via a communications network to a central location. The present invention then sorts all the photographs according to their identity, through the association of identification means at the source of photo capture, and prepares the photos for delivery to the corresponding guest. This is all accomplished transparently to the guest, with little to no effort involved.

Delivery may take a variety of forms. A web page may be created for the guest, and the photos presented to the guest for viewing at a later time. The photos could easily be viewed in the comfort of the guest's home through an internet connection. The photos, or a link to the photos, could also be sent to the guest via e-mail. The present invention also allows guests to view their photos from the television in their hotel room. Kiosks could also be located throughout the park to allow for viewing of photos. For vacation guests, at the end of their stay, they may be given a CD-ROM containing all their photos to take home with them, in addition to venue related creative content, and photo editing software.

The present invention incorporates picture taking of all different kinds. For example, the present invention is designed to collect images from venue sources such as traditional roving photographers and thrill shots taken of guests while on rides, as mentioned previously. The present invention also introduces new methods of picture taking. One new method of picture taking is the introduction of digital photo spots whereby a digital camera is mounted at a location, and guests are able to pose in front of the camera, triggering the camera either themselves or by some sort of sensor nearby.

Although the present invention may be implemented in a venue such as a theme park, it should not be limited to locations such as theme parks. The venue could likewise be a hotel or resort, a cruise, or other attraction. Also, the venue could be a combination of entities, such as theme park and surrounding hotels or property.

It is an objective of the present invention is therefore to create a new guest experience centered around picture taking in vacation spots such as theme parks. The present invention aims to enhance current traditional and digital photo services to capture and preserve images in a hassle-free environment, as well as introduce more product offerings. The present invention allows for more widespread distribution of photographs and avoids the common problems of prior art methods in that no longer would a guest be “out of luck” if they did not purchase a photograph from within the park before closing time. By fundamentally changing the approach to picture taking at a theme park, it is expected that guests will attach a whole new attitude to their experiences at a theme park or vacation spot.

### BRIEF DESCRIPTION OF THE DRAWINGS

FIG. 1 is a flow diagram showing a top-level view of the present invention.

FIG. 2 is a flow diagram of an exemplary embodiment of the present invention.

FIG. 3 illustrates an exemplary embodiment of ID media of the present invention.

### DETAILED DESCRIPTION OF THE INVENTION

The image capture system and method of the present invention aims to create a more pleasant and rewarding guest experience by providing a centralized system for capturing many different types of images from multiple sources. The present invention utilizes a method of attaching identity to photographs taken. The present invention then stores the photographs centrally and provides unique and convenient methods for guests to view their photos. The present invention further provides many options other than simply ordering traditional prints of their favorite photo.

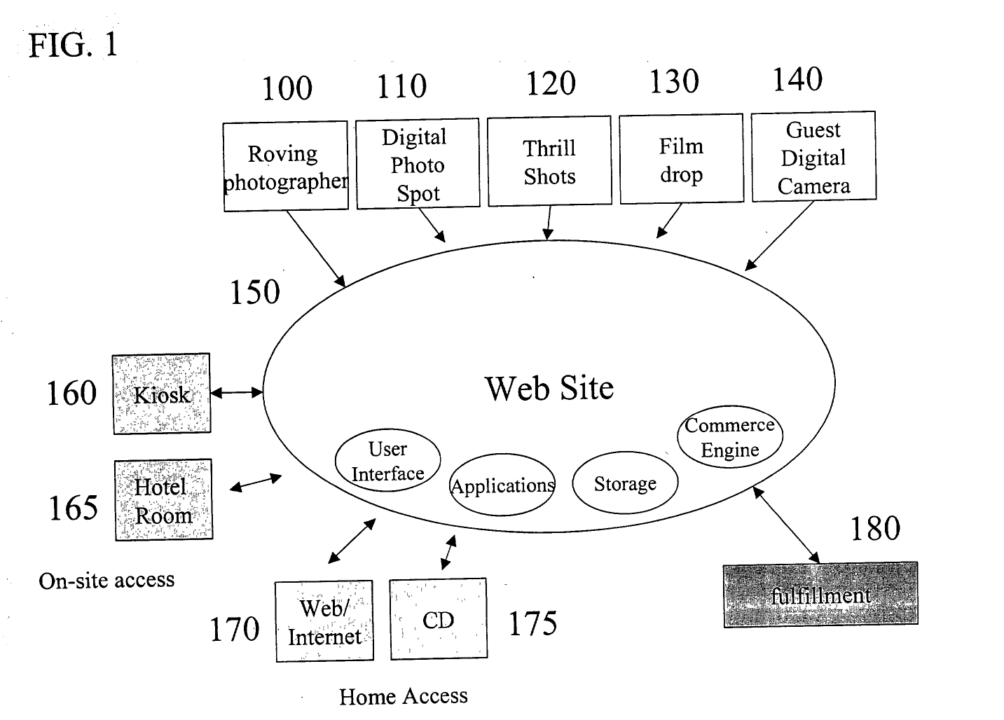

FIG. 1 illustrates a top level of the image capture system of the present invention that identifies specific input, access, fulfillment, and guest ID resolution functions. This top-level layer as shown is responsible for the acquisition, management, storage and access of guest images.

Acquisition of images can come from many different image sources. It is foreseen that almost any type of image source could interface with the system and method of the present invention. Images are associated with an ID and collected from these various sources and transferred to a centralized location. The image sources preferably are networked with the central location, however in certain cases, such as film drop boxes, this is not always possible.

Image sources at a venue such as a theme park, for example, may include roving photographers 100, digital photo spots 110, thrill shots 120, film drops 130, and guest digital cameras 140. These sources are described later in more detail.

Images are collected and managed by a centralized system 150 as depicted in FIG. 1. Images are stored in a centralized location 150 and made available for viewing through this centralized system 150.

Access to images by a guest can be either on-site or off-site. For example, kiosks 160 are preferably located throughout a venue to provide guests with the ability to view their photos. Kiosks 160 may be “self-serve” computers that are networked with the system of the present invention. These computers are operated by the guest by using their ID media. The kiosks 160 may also be operated by an employee.

Hotels affiliated with the venue may provide access to photos using an in-room device 165. The in-room device 165 may preferably utilize the television to view and manipulate photos. On screen navigation is preferably handled through a remote control or keyboard.

The present invention also provides for viewing of photographs at just about any off-site location through use of the Internet 170. The present invention will preferably have a dedicated website where guests may later access their photos for viewing, as well as perform other functions such as image manipulation and scrapbook creation. Yet another example of off-site access is a photo CD 175 which may be sent to the guest's home after their visit.

The present invention also provides for a whole host of guest fulfillment products 180. Guests will be able to order prints, create photo albums and other gift items.

In order to achieve these, and other objects of the present invention as discussed thus far, an association scheme is needed. Another major object of the present invention is therefore, to associate the guest with their photo(s). The association should minimize inconvenience to guests and not impede workflow.

In one embodiment of the present invention, the venue shall assign a unique ID to each guest. The time and location of the ID generation depends on individual guest circumstances. For example, the guest may be assigned an ID upon entrance to the venue, or the guest may be assigned an ID before entrance, through a reservations system or website. The ID is preferably a number, however it may be any way of unique identification.

An ID is assigned to a guest preferably by distributing ID media to the guest. ID media may take the form of a card with a magnetic stripe. The ID media could also be a barcode.

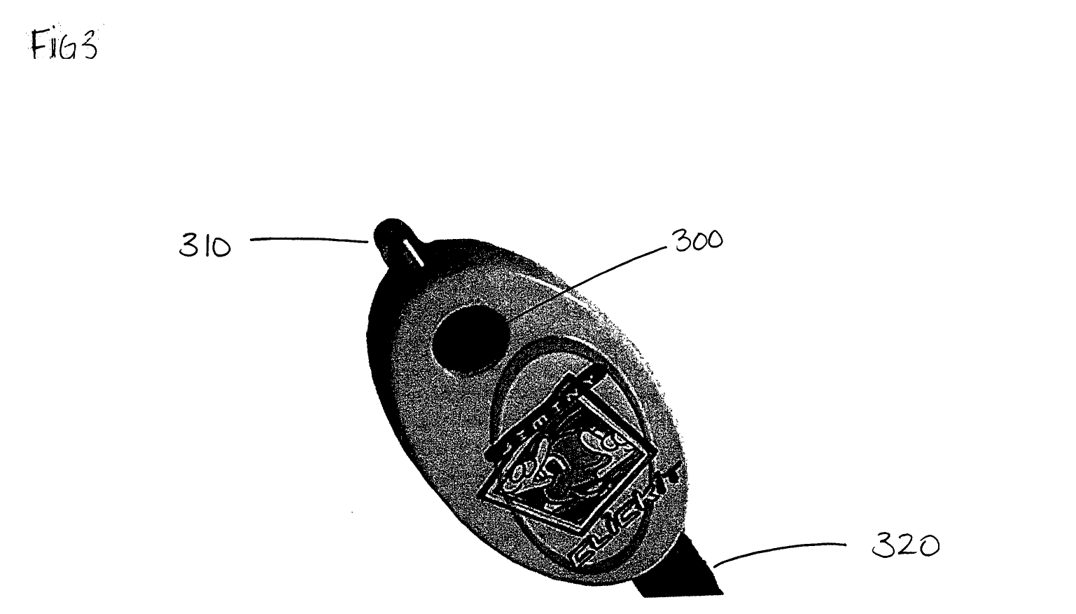

Infrared technology could be used to wirelessly transmit data that represents the guest ID. This could be implemented with custom made devices distributed by the venue, or with guest devices such as PDA's, cell phones, or other handheld electronic devices having an infrared communications port. A example of ID media using infrared signals is shown in FIG. 3. The ID media consists of a button 300 and infrared transmitter 310. The infrared transmitter may take the form of an infrared LED. The ID media may, for example, be attached to a lanyard 320 and worn around the neck or wrist, worn on a person's clothing as a pin, or attached to a key chain. When the guest pushes the button 300, data is transmitted via IR signals. The data contains the guest ID, and preferably other information. In this embodiment of the present invention, image capture sources will utilize infrared receivers to receive the IR data from the ID media. The exemplary embodiment of Infrared ID media as shown in FIG. 3 is only one example of how the ID media may take form. The form, shape, and size of the ID media may change.

Guests should carry the ID media at all times. Therefore the ID must be portable. The ID must easily be read at each image capture location, including high volume thrill rides, and not inconvenience guests or impede operations. The ID media is also preferably inexpensive.

The ID must be associated with guest information such as name, address, and email address. For this, an account is separately created. The account preferably contains guest information such as name, mailing address, email address, etc. The account is then associated with an ID. Multiple ID's can be associated with a single account. For example, a family may consist of several guests. Each guest in the family may be issued a separate ID. However, instead of creating individual accounts for each ID, a single family account is created which is associated the multiple ID's. The single account can therefore collect all the images associated with each of the ID's for viewing in a single place.

Guests who make a reservation will preferably have an account automatically created for them. The reservation system may automatically create an account using information about the guest already stored in the reservation system. The guest may be invited via a confirmation letter or email to activate their account prior to arrival.

Other guests will have the opportunity to create accounts at an in-park kiosk or via the Internet. For example, day guests might use their ID at a kiosk on property by entering required information to create an account. In-park kiosks would associate the ID media (that has references to all their pictures) with an account name by either creating an account or associating photos with an existing account.

Guests visiting the venue may frequently be issued ID media, and spend the day generating imagery without having created an account. A holding account shall exist to store this imagery. Images that are left unclaimed in the holding account may be deleted after a specified amount of time. The guest may create an account after their visit by visiting a web site and creating an account by entering required information. Accounts for unassociated ID's shall be distinguishable from those associated with ID's for administration purposes. Guests can create an account anytime before, during or after their visit.

An account need not be created before images can be stored, but must be created before a guest can interact with them via the web site, or other image access. The ID and account name are preferably different. This allows images from guests who have not yet been associated to be sent to a temporary account in the system, giving the user flexibility in choosing an account name, and giving the venue flexibility in choosing and ID scheme.

Once a guest creates an account using their media, the account creation process will query the holding account to determine if prior images have been uploaded. If so, these images will be associated with the newly created account.

Account creation should be as non-intrusive as possible. Account creation requirements may be different at different access points. For example, email address may not be required because not everyone has email, and not all items may be required at a kiosk because it takes too long, so we should capture it at home when the guest has more time.

An associated ID engine exists to take images associated with IDs and deposit them in the appropriate accounts.

Additional information besides just the guest ID may be associated with each image. For example, a date and time stamp may be associated with an image. Other information that may be associated with images include an origin code which identifies where the picture was taken, what camera the image was captured from, or who the photographer was. Purchase history or promotional codes may also be associated with an image. The guest may have the ability to view this associated data from the access point.

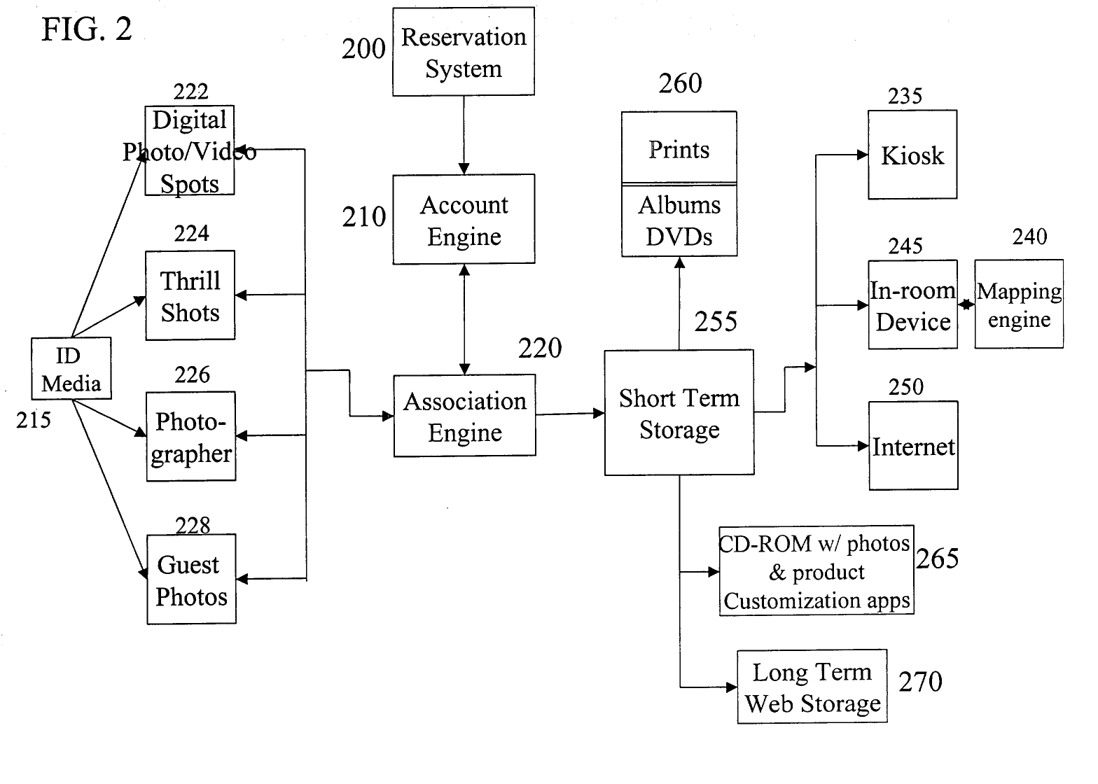

FIG. 2 illustrates the image capture system and method of the present invention in further detail. As mentioned above, a guest who has made a reservation to visit a venue or accommodations associated with a venue will preferably have an account automatically created using the guest information from the reservation system 200. Reservation system 200 communicates with the account engine 210 to provide the information required to create a new account. Account engine 210 is responsible for adding and deleting accounts.

An account in accordance with the present invention should be associated with at least one ID. The association engine 220 is responsible for this task. The association engine 220 communicates with account engine 210 to associate a guest ID 215 with a newly created account. The association engine may simply be a database which links guest ID with the proper account.

Digital photo spots 222 are capture points throughout a venue where guests activate a digital camera while standing in a designated location. Digital photo spots 222 are generally activated by the system recognizing one or more guest ID's through ID media 215. For example, the guest swipes their a card with a magnetic stripe at the digital photo spot. The ID is recognized by the photo spot, and a timer counts down the time until the picture is taken. One or more continuous frames are taken and designated against that ID.

The photo(s) will be captured and in some embodiments, and queued for moderation. The digital photo(s) will then be sent to the association engine 220. The association engine 220 requests the account corresponding to the guest ID from the account engine 210. The photo will then be transmitted for storage to the proper account. If the guest ID has not yet been associated with an account, it will be stored in a temporary holding account. Photos are preferably held in the temporary holding account until an association event ties the guest ID to an account, or a period of time has elapsed upon which the photos are deleted.

Thrill Shots 224 are event imaging systems installed at thrill rides around a theme park property to capture images of guests at the most exciting moment of the ride. Traditionally, when guests exit the attraction, they encounter monitors that display the most recent images. Once they have located their image, the guest notes the image number and moves to a counter for purchase of the image. The combination of the unique imagery and excited state of the guest can lead to significant numbers of impulse purchases at the venue. Unfortunately, the volume of guests can easily overwhelm the space constrained viewing and purchasing locations, leading to long lines and lost revenue opportunities.

For thrill ride photos, guest ID's are not as easily read at photo capture. Therefore, ID association may need to occur after photo capture. In one embodiment, no guest ID's are read at photo capture. The photos may be sent to the association engine with a special ID instead of the guest ID. The special ID will cause the photo to be placed in holding. Separately, guests will have the opportunity to associate themselves with their thrill ride photo. For example, the guest may view images just taken on a video monitor outside the ride. Each image may have a number assigned to it. The guest would note the image number and then use a device or manned location to associate the image number and the guest's ID. The device, for example, would have an ID media reader and a keypad. The guest would use the device to enter the image number on the keypad and then have their ID media read to associate image and ID.

For ID media using wireless communications signals, such as infrared and radio frequency signals, it is possible to transmit the ID wirelessly at or close to the time of image capture. In this case, a infrared (or other wireless communications) receiver may be located in one position along the ride's path. For example, on a roller coaster, an infrared receiver may be located in a position alongside the track while the cars slowly ascend to the top of the structure. A sign may instruct guests on the ride to trigger their ID media to send a signal as they pass the receiver. The receiver may be able to identify each car, by timing, or other trigger. Photos are taken at a later point in the ride. The photos could then be associated with each car, and further associate the riders in each car with the image.

In yet another embodiment of the present invention, a guest's ID is read upon entrance to the ride. The system of the present invention reads guest ID's based on ride car location and can associate each photo with the ID's by location on the ride.

At various locations throughout a theme park, photographers 226 capture pictures of guests. The photos may be of guests in front of a special backdrop such as a painted canvas or one of the park icons. The photos could also be of the guests with a special character. The photos could also be candid photos of guests. The photographer 226 will ask the guest for an ID to associate with their image. If they do not have an ID, guests will receive a numbered ticket, which is brought to a location where their images may be viewed, printed, and purchased. A variety of equipment and software can be used to capture photographs.

Photographers 226 such as roving photographers, restaurant and green screen photographers will also be equipped with guest ID reading devices. Just before or after a photo is captured, one or more guest ID's will be read. In some embodiments, photos are moderated by the photographer 226. The photos, upon download from the cameras, will be sent to the association engine and processed like digital photo spots, as described above.

Guests may be able to take pictures with their own digital cameras 228 and upload them to the image capture system of the present invention while at the venue by using designated kiosks throughout the venue. In some embodiments, images may be moderated by an employee before being uploaded to the system for storage.

Guest film 228 may also be processed and digitized into the image capture system by dropping film at a designated location in or around the venue. All rolls of film dropped off will be scanned into the image capture system. After film is processed, it will need to be associated with the guest's ID when paid for at the POS terminals. After that transaction, photos will be available for viewing in the guest's hotel room, or on the web site, which can also be accessed in the park or at home via the Internet.

Photos captured before the guest ID is associated with an account are held in photo holding. When the guest associates the guest ID with their account, photo holding is searched, and the appropriate photos are associated with the guest's account.

Moderation of image content to prevent inappropriate content may be utilized, but is not a requirement of the present invention. If an image is determined to be inappropriate, it may be replaced with a message to the guest to let them know that their photo was not simply lost.

Guests can access the present invention in a variety of ways. As mentioned previously, kiosks may be located throughout a venue for the guest to use to create accounts, view photos, or perform other functions. Kiosk 230 is preferably accessed by reading the guest's ID media. For example, in one embodiment where the ID media is a card with a magnetic strip, the kiosk 230 has a magnetic strip reader and the guest swipes their card in the reader in order to access the system. In another embodiment, kiosk 230 may have an infrared receiver capable of receiving infrared data from ID media transmitting the guest ID via infrared signal. Kiosks could be multi-functional machines, not only for viewing, but for dispensing ID Media, for setting up or managing accounts, or potentially buying merchandise.

In another embodiment of the present invention, the guest may be staying in a hotel which is affiliated with the venue. The hotel may offer access to the image capture system through use of an in-room device 245. In this embodiment, the guest may not need to use their ID media to access the system. Instead, the hotel may utilize an account mapping engine 240 which allows the guest automatic access to their photos. The account mapping engine locates the account based on information already stored about the guest staying in that hotel room.

In yet another embodiment of the present invention, guests may access their photos through the Internet 250 by visiting a web page. The guest may visit a known web address and log onto their account using already established username and password, or as mentioned previously, create a new account at the website. In an alternative embodiment, the guest is emailed a URL which directs them to their account or photos.

By accessing the present invention through one of the many access points, such as kiosk 225, in-room device 245, or the Internet 250, the guest has the ability to perform many different functions. The primary function is to view photos, however the present invention preferably provides tools such as photo manipulation and photo storage.

The access point may provide the guest with the ability to sort their photos into different photo albums. The album may be titled by the guest, and captions may be added to photos so as to tell a story. The guest has the ability to easily add or remove photos from an album. The system may provide different backgrounds or stock images to help in creation of albums. Albums may also be shared among friends and family.

Ownership of photos includes certain editing functions such as deleting a photo from a roll, deleting a roll from an account, uploading pictures to an existing roll, renaming a roll, or changing a caption of a photo in an album. As a consequence, those who are shared with do not have photo ownership rights and do not have access to these functions. In addition, many guests will have the same photo in their account. If one guest captions the photo, their caption should not appear on the photos of other guests. For example, a copy of the photo will likely need to be placed into each account, rather than providing references to one photo.

Photos could be grouped in two separate ways. Venue taken images, and guest taken images. There may also be other sorting options, or custom sorting. Photos should be viewable in at least two sizes. A thumbnail sized image, for example, may be shown, and screen resolution sized image for full screen viewing. Guests should be able to go back and forth between these two sizes easily, perhaps just by clicking on the image itself. The size of photographs may be edited. The present invention should also provide slide show capability.

In one embodiment of the present invention, short term photo storage 255 is offered for free to guests. Images would be stored for a predetermined period of time, for example, 30 days, and after that time the images would expire. Upon expiration, guests would then be required to purchase a picture CD or long term storage in order to keep their photos, if they have not so already. Otherwise, photos may be deleted after the predetermined period of time. Email is sent announcing the expiration of photos.

Interest in having photos stored on CD has grown over the past few years, and is particularly attractive to digital camera users because they understand CDs are a more permanent/stable storage medium than online storage. Users should be able to group their favorites together online so they can order a CD. The CD may additionally contain venue content and easy to use photo software that allows the guest to enhance photos with creative content. In some embodiments of the present invention, a CD-ROM or DVD is included in a guest's vacation package and given as a souvenir to the guest at the end of their stay.

Long term storage 270 may be offered for a fee to guests for who desire on-line storage of images. Benefits of on-line storage includes easily sharing photos with friends and family. On-line storage may also have many of the same benefits in functionality as the access points described above. For example, the web-site may offer image manipulation tools and easy ordering of prints, which may not be directly available with a CD-ROM.

A number of products and merchandise can be offered through the image capture system of the present invention. For example, a guest can select one or more photos to create framed prints from. The access point may offer a selection of frames that the print may be framed in. Prints will be made in the selected size and shipped in the frame selected by the guest to the guest's home, or even to a relative. The guest could also choose to create a real printed photo album containing all or selected photos from the image capture system. The image capture system may provide templates such as a creative border that can be added to the user's photos or the ability for the user to insert their picture into a special background.

Many users prefer to print their photos at home. Settings may be provided to the user so that they can make a good home print. This feature would require the ability to download prints for guest-taken photos only.

Greeting cards & postcards are yet another product that may be created using photos from the image capture system. The greeting card or postcard could be created while the guest is still at the venue from an on-site access point, and mailed by regular mail or by electronic mail directly by the system.

The image capture system could offer just about any type of merchandise that is easily personalized. Calendars, t-shirts, books, games, puzzles, posters, toys, desk accessories, stationary products, and mugs are just a few of the many things a guest could create with the present invention.

It should be noted that this system could be easily modified to capture video and audio as well as images. Currently, bandwidth limitations restrict the ability to capture, transmit, and store good quality audio. However, it is anticipated that video and audio capture should be alternatives to image capture has been described herein.

In closing it is to be understood that the embodiments disclosed herein are illustrative of the principals of the invention. Other modifications may be employed which are within the scope of the invention; thus by way of example, but not of limitation, alternative sources of image capture. Additionally, other types of ID media may be provided for use in the present invention. Accordingly, the present invention is not limited to that precisely shown and described in the present specification.

What is claimed is:

1. An image capture method comprising the steps of;
assigning identification media to a guest at a venue;
providing a plurality of sources of image capture within the venue;
associating the guest's identification media with each image captured;
transmitting the images from sources of image capture to a central location;
sorting the images according to the associated identification means; and
delivering selected images to each guest.

2. The method of claim 1 wherein the step of delivering is by providing said images available for viewing on an Internet website and notifying the guest of said website URL.

3. The method of claim 1 wherein the step of delivering is by mailing image prints to the guest's home address.

4. The method of claim 1 whereby the step of delivering is by recording the photos onto a CD-ROM and mailing the guest.

5. The method of claim 1 wherein said identification means is a card with a magnetic stripe or fob.

6. The method of claim 1 wherein said sources of image capture includes at least one roving photographer located throughout the venue.

7. The method of claim 1 wherein said sources of image capture include photos taken of a guest on a ride.

8. The method of claim 1 wherein said sources of image capture include a guests' digital or film camera.

9. The method of claim 1 wherein said sources of image capture are digital photo spots located throughout the park.

10. The method of claim 1 further comprising the step of creating an account associated with the identification means, whereby the account contains information about the guest.

11. The method of claim 1 wherein the venue is a theme park.

12. The method of claim 1 wherein the venue is a cruise ship.

13. The method of claim 1 wherein the venue is a vacation resort.

14. The method of claim 1 wherein the venue is one or more selected from the group consisting of a theme park, cruise ship, hotel, resort, or exhibition hall.

15. An image capture system, comprising:
a plurality of sources of image capture located throughout a venue;
identification means distributed to guests for associating images taken at each of the plurality of sources of photo capture with the proper guest;
a central database;
a communications network for transmitting images from each of the plurality of sources of photo capture to the central database;
a central processor for sorting images based on identity;
a storage medium for storing images; and
means for delivering selected images to guests.

16. The image capture system of claim 15 wherein the means for delivering photos to guests is an Internet website.

17. The image capture system of claim 15 wherein the means for delivering photos to guests is an in-room device.

18. The image capture system of claim 17 wherein the in-room device is a television set in the guest's hotel room.

19. The image capture system of claim 15 wherein the means for delivering photos to guests is via e-mail.

20. The system in accordance with any one of claims 15 to 19 wherein said identification means is arranged to validate at least one type of identifying information from the group consisting of: magnetic strip, bar code, infrared, radio-frequency, iris, fingerprint, retina, voice, thermal, finger or hand geometry, and visual identification.

21. A method of image capture, the method comprising the steps of:
assigning a guest at a venue an ID;
providing the guest with ID media, the ID media containing their ID;
providing a plurality of image capture sources throughout the venue;
providing ID media reading means at each image capture source;
associating each image captured with an ID by reading the ID media closely related in time to capture of an image;
transmitting the image with the associated ID to a central location;
reading the ID from the photo and looking up the account; and
storing the photo.

22. The method of claim 21 wherein an account exists and the photo is stored in the appropriate account.

23. The method of claim 21 wherein an account does not yet exist for the guest, and the photo is stored in a temporary holding account.

24. The method of claim 21 wherein ID media comprises an infrared transmitter and ID media reading means comprises an infrared receiver.

25. The method of claim 1 wherein said identification means is a device with an infrared transmitter.
